(19) United States
(12) Patent Application Publication
(10) Pub. No.: US 2009/0317760 A1
(43) Pub. Date: Dec. 24, 2009

(54) MULTI-LUMEN ASPIRATOR DEVICE

(76) Inventor: Anthony Michael Gadbois, Columbia, MO (US)

Correspondence Address: POLSINELLI SHUGHART PC, 700 W. 47TH STREET, SUITE 1000, KANSAS CITY, MO, 64112-1802, US

(21) Appl. No.: 12/489,014

(22) Filed: Jun. 22, 2009

Related U.S. Application Data
(60) Provisional application No. 61/132,607, filed on Jun. 20, 2008.

(51) Int. Cl. A61C 17/08

(52) U.S. Cl. 433/91

(57) ABSTRACT

A multi-lumen aspirator device having an elongated body with a plurality of lumens disposed therein for reducing the sound level generated during the operation of the device is disclosed. The elongated body defines a proximal opening that communicates with a distal opening through an inner conduit. The plurality of lumens is disposed within the inner conduit such that a central lumen of the plurality of lumens is surrounded by the remaining plurality of lumens such that laminar flow is established through the multi-lumen aspirator that promotes the reduction in sound generated by the multi-lumen aspirator device during operation.

### CROSS REFERENCE TO RELATED APPLICATION

This is a non-provisional patent application, which claims benefit of U.S. Provisional Application No. 61/132,607, entitled “Noise Reducing Dental Suction Tube”, filed on Jun. 20, 2008 and is herein incorporated by reference in its entirety.

### FIELD

This document relates to a multi-lumen aspirator device useful in the removal of gases, fluids, and debris, and in particular to a multi-lumen aspirator device that promotes laminar flow, reduces noise generated during operation, and inhibits clogging.

### BACKGROUND

Aspirator systems consisting of a vacuum source connected to a handheld nozzle having a hollow tip are widely used in various fields. Aspirator systems are particularly widespread in the medical and dental fields. For example, practitioners in the dental industry use aspirator devices to remove saliva, blood, water, and debris from the patient's mouth. In a surgical setting, the accumulation of blood or other bodily fluids can quickly obscure the field of view for surgeons making the surgical procedure more dangerous. The turbulent flow of fluid and debris through the aspirator device combined with the constant drone of the vacuum source can also create an excessively noisy environment that may be detrimental to the hearing of the professional. In addition, the excessive noise from an aspirator can also disrupt vital communication between professionals performing the procedure, thus compounding the potential dangers to the patient that may be associated with the procedure.

Another drawback of existing aspirator devices is that fluid or debris that are being removed can clog the device, especially a device having a single lumen. In addition, other debris or tissue remains in or near the area being aspirated may also clog the aspirator device. Therefore, there exists a need for a quiet, low-noise generating aspirator device that can continue to provide sufficient suction should one or more lumens become clogged.

### SUMMARY

In an embodiment, a multi-lumen aspirator device may include a hollow elongated body defining an inner conduit in communication with a proximal opening and an opposing distal opening. A plurality of lumens are disposed longitudinally along the inner conduit of the elongated body for providing fluid flow communication between the proximal and distal end openings, wherein one of the plurality of lumens is disposed along the central longitudinal axis of the inner conduit and surrounded by a remainder of the plurality of lumens in parallel arrangement.

In another embodiment, a multi-lumen aspirator device may include a hollow elongated body defining an inner conduit in communication with a proximal opening and an opposing distal opening. A plurality of lumens may be disposed along a longitudinal axis of the inner conduit between the proximal and distal openings for establishing fluid flow communication between the proximal and distal end openings, wherein the plurality of lumens establishes laminar flow through the inner conduit.

In yet another embodiment, a multi-lumen aspirator system may include a multi-lumen aspirator device having a hollow elongated body defining an inner conduit in communication with a proximal opening and an opposing distal opening. A plurality of lumens may be disposed along a longitudinal axis of the inner conduit between the proximal and distal openings for establishing fluid flow communication between the proximal and distal end openings. In one aspect, one of the plurality of lumens may be disposed along the central axis of the hollow elongated body and surrounded by a remainder of the plurality of lumens in parallel arrangement along the longitudinal axis of the inner conduit. The multi-lumen aspirator device may be in fluid flow communication with a source of vacuum for generating a suction force through the plurality of lumens such that the suction force generated by the vacuum source draws fluid and/or debris through the plurality of lumens, wherein the suction force generated by the vacuum source through the plurality of lumens establishes a laminar flow through the device.

Additional objectives, advantages and novel features will be set forth in the description which follows or will become apparent to those skilled in the art upon examination of the drawings and detailed description which follows.

### BRIEF DESCRIPTION OF THE DRAWINGS

FIG. 1 is an elevated perspective view of one embodiment for a multi-lumen aspirator device;

FIG. 1A is an enlarged view of FIG. 1 showing the distal end portion of the multi-lumen aspirator device;

FIG. 2 is a side view of the multi-lumen aspirator device;

FIG. 3 is a cross-sectional view taken along line 3-3 of FIG. 2 for the multi-lumen aspirator device;

FIG. 4 is a top view of the multi-lumen aspirator including a plurality of lumens disposed therein shown in phantom; and

FIG. 4A is an enlarged view of FIG. 4 showing the plurality of lumens and the laminar flow through the multi-lumen aspirator device.

Corresponding reference characters indicate corresponding elements among the view of the drawings. The headings used in the figures should not be interpreted to limit the scope of the claims.

### DETAILED DESCRIPTION

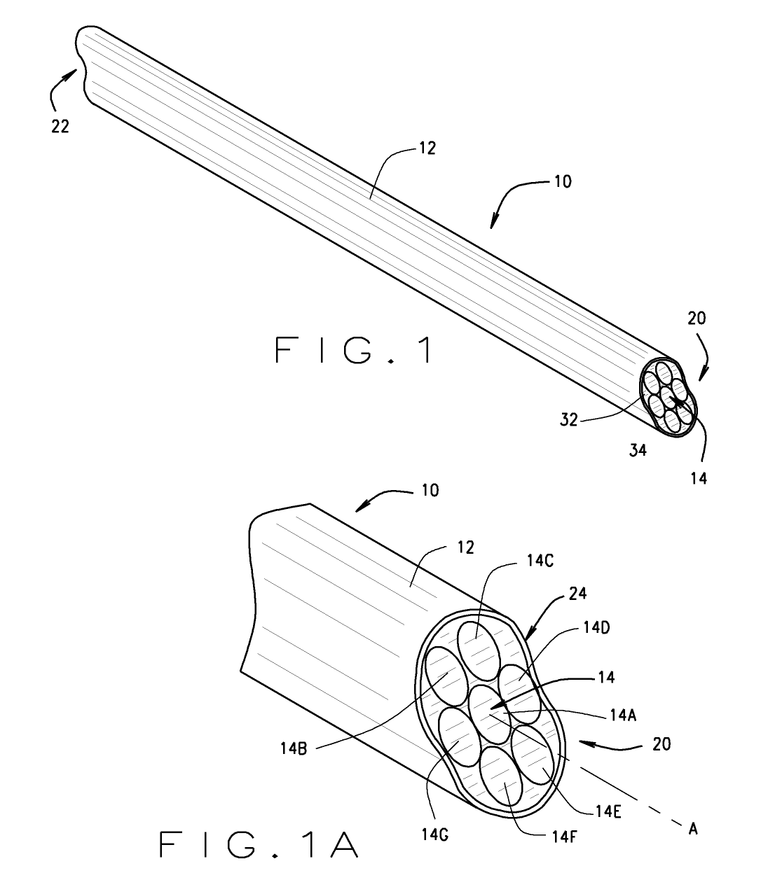

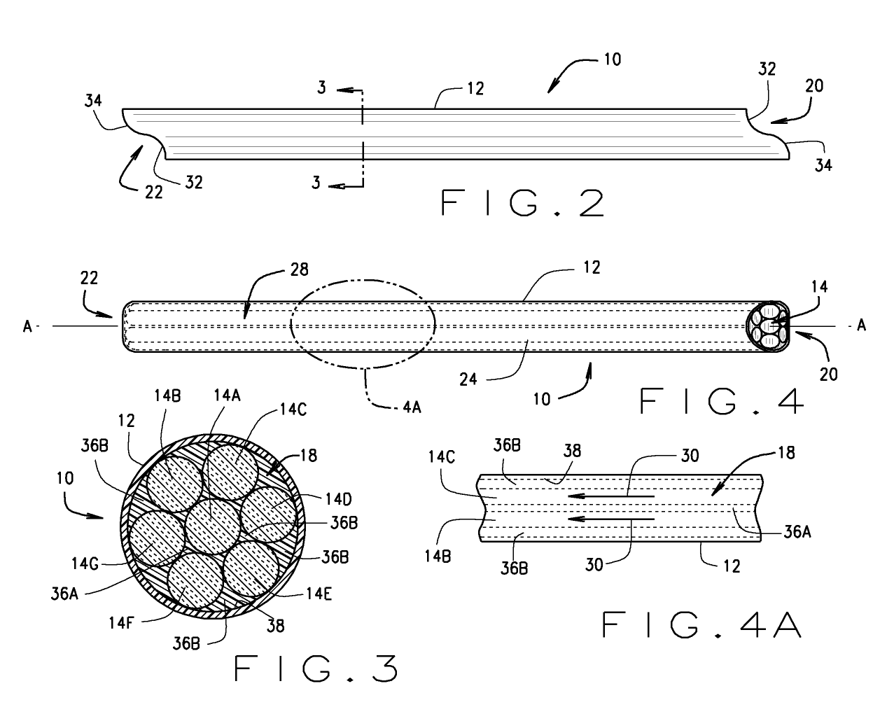

Referring to the drawings, an embodiment of the multi-lumen aspirator device is illustrated and generally indicated as 10 in FIG. 1. As shown in FIGS. 1 and 2, the multi-lumen aspirator device 10 has a hollow elongated body 12 that defines an inner conduit 18 formed by an inner surface 38 that is in fluid flow communication with a proximal opening 20 and an opposing distal opening 22. The proximal and distal openings 20 and 22 each define an S-shaped curve configuration having a lower convex portion 32 which transitions to an upper concave portion 34. The S-shaped configuration of the proximal and distal openings 20 and 22 facilitate the collection of fluid and debris into the multi-lumen aspirator device 10. In one embodiment, the proximal and distal openings 20 and 22 of the multi-lumen aspirator 10 have the same S-shaped curve configuration, although in other embodiments the proximal and distal openings 20 and 22 of the multi-lumen aspirator 10 may have different configurations.

As further shown, the multi-lumen aspirator 12 includes a plurality of lumens 14 disposed within the inner conduit 18 of the hollow elongated body 12 in a longitudinal and parallel manner along an central axis A as illustrated in FIG. 4. In one embodiment shown in FIGS. 1A, 3 and 4A, the plurality of lumens 14 may be arranged within the inner conduit 18 of the elongated body 12 such that a central lumen 14A is disposed centrally along central axis A of the multi-lumen aspirator device 10 and the remaining outer lumens 14B-14G surround the central lumen 14A. In this embodiment, there may be six outer lumens 14B-G, although other embodiments may have more lumens 14. As defined herein, axis A represents the longitudinal axis along the elongated body 12 of the multi-lumen aspirator device 10. In this arrangement, a plurality of interstitial spaces 36A are defined between the central lumen 14A and any two adjacent outer lumens 14, while another plurality of interstitial spaces 36B are defined between any two adjacent outer lumens 14 and the inner surface 38 of the elongated body 12. In one embodiment, the interstitial spaces 36A and 36B may be filled with a plastic material during the extrusion process that prevents fluid flow between each of the plurality of lumens 14, and therefore establishes laminar flow only through the plurality of lumens 14.

In one aspect, the multi-lumen aspirator 10 is part of an overall system in which either the proximal opening 20 or the distal opening 22 of the hollow elongated body 12 may be engaged to a source of vacuum (not shown) for drawing fluid and debris through the plurality of lumens 14. Flexible hollow tubing (not shown) may be engaged to the hollow elongated body 12 for establishing fluid flow communication between the source of vacuum and the multi-lumen aspirator device 10 in order to permit the collected fluid and debris to be evacuated to a suitable waste collection source. In another aspect, the multi-lumen aspirator device 10 has particular application in the field of dentistry for collecting fluid and debris by applying a constant source of vacuum to the patient's oral cavity, while also reducing the level of sound normally generated by the operation of the multi-lumen aspirator device 10.

For example, the Applicant has conducted noise level tests in which a decibel device that measures the level of sound was positioned 15 inches away from a prior art dental suction tube having a single lumen while the same test was also performed with the multi-lumen aspirator device 10 at the same distance. Both the prior art dental suction tube and the multi-lumen aspirator device 10 were performed with vacuum set at the same regular high volume suction normally used in dental applications. The decibel reading of the prior art dental suction tube was 93 decibels while the decibel reading of the multi-lumen aspirator device 10 was 71 decibels which results in a 22 decibel reduction in sound between the prior art device and the multi-lumen aspirator device 10.

Referring to FIG. 4A, this substantial 24% reduction in sound level achieved by the multi-lumen aspirator device 10 is due to the laminar flow 30 of fluid caused by the fluid traveling through the plurality of lumens 14 of the elongated body 12. In particular, it has been found by the Applicant that the arrangement of the plurality of lumens 14 within the elongated body 12 in which the central lumen 14A is surrounded by the outer lumens 14B-G promotes the laminar flow 30 of fluid and debris that enters the elongated body 12 through either the proximal or distal openings 20 and 22.

In one embodiment, the plurality of lumens 14 may have the same circular cross-sectional configuration as illustrated in FIG. 3; however, it is contemplated that the plurality of lumens 14 in other embodiments may have an oval, elliptical, square, or rectangular cross-sectional configurations. In another embodiment, the elongated body 12 may have a circular cross-sectional configuration, but may also define oval, elliptical, square, or rectangular cross-sectional configurations.

In an embodiment, the hollow elongated body 12 and the plurality of lumens 14 may manufactured from a durable hard medical-grade plastic material that is capable of being extruded during manufacture of the multi-lumen aspirator device 10. During manufacture, the multi-lumen aspirator device 10 may be extruded as one piece using a single plastic material such that the interstitial spaces 36A and 36B between the lumens 14 is filled with plastic material when the elongated body 12 is extruded, although in the alternative the interstitial spaces 36A and 36B may be later filled with the same plastic material after the elongated body 12 has been extruded. In another embodiment, the elongated body 12 may have a thinner width in comparison to the width of each of the plurality of lumens 14, although in other embodiments the wall thickness of each of the plurality of lumens 14 and elongated body 12 may be the same or the wall thickness of each of the plurality of lumens 14 may be thinner than the elongated body 12.

In one embodiment, the elongated body 12 may be 6 inches in length, while the diameter of the proximal or distal openings 20 and 22 may be 0.4375 inches each. Moreover, radius from the center of the outer lumens 14B-G and the center of the center lumen 14A may be 0.265 inches, while the thickness of the wall that defines the elongated body 12 may be 0.023 inches. However, other measurements for the multi-lumen aspirator device 10 are contemplated. Moreover, the openings of each of the plurality of lumens are sized and shaped to prevent entry or entrapment of large debris into the plurality of lumens 14. Preventing large debris from entering and/or becoming entrapped within the plurality of lumens 14 also prevents veneers and crowns from being damaged by such trapped large debris. In addition, the plurality of smaller openings defined by lumens 14 prevents damage to dental prosthetics due to accidental aspiration of the veneer during operation of the aspirator 10 which can occur with single lumen aspirators of the prior art.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A multi-lumen aspirator device comprising:
a hollow elongated body defining an inner conduit in communication with a proximal opening and an opposing distal opening with a plurality of lumens disposed longitudinally along the inner conduit for providing fluid flow communication between the proximal and distal end openings, wherein one of the plurality of lumens is disposed along the central longitudinal axis of the inner conduit and surrounded by a remainder of the plurality of lumens in parallel arrangement.

2. The multi-lumen aspirator device of claim 1, wherein each of the plurality of lumens defines has a same cross-sectional configuration.

3. The multi-lumen aspirator device of claim 2, wherein each of the plurality of lumens defines a circular cross-sectional configuration.

4. The multi-lumen aspirator device of claim 2, wherein each of the plurality of lumens defines an oval cross-sectional configuration.

5. The multi-lumen aspirator device of claim 2, wherein each of the plurality of lumens defines an elliptical cross-sectional configuration.

6. The multi-lumen aspirator device of claim 1, wherein the distal opening of the hollow elongated body defines an S-curve configuration having a lower convex portion that transitions to an upper concave portion.

7. The multi-lumen aspirator device of claim 6, wherein the proximal opening of the hollow elongated body defines an S-curve configuration having a lower convex portion that transitions to an upper concave portion.

8. The multi-lumen aspirator device of claim 1, wherein each of the plurality of lumens is separated by the at least one interstitial space filled with a material.

9. The multi-lumen aspirator device of claim 1, wherein the plurality of lumens are aligned in parallel arrangement for causing laminar flow through the plurality of lumens.

10. The multi-lumen aspirator device of claim 9, wherein laminar flow through the plurality of lumens reduces the sound generated by fluid flow through each of the plurality of lumens.

11. A multi-lumen aspirator device comprising:
a hollow elongated body defining an inner conduit in communication with a proximal opening and an opposing distal opening with a plurality of lumens disposed along a longitudinal axis of the inner conduit between the proximal and distal openings for establishing fluid flow communication between the proximal and distal end openings, wherein the plurality of lumens establishes laminar flow through the inner conduit.

12. The multi-lumen aspirator device of claim 11, wherein the laminar flow established by the plurality of lumens reduces the sound generated by fluid flow collectively through the plurality of lumens.

13. A multi-lumen aspirator system comprising
a multi-lumen aspirator device including a hollow elongated body defining an inner conduit in communication with a proximal opening and an opposing distal opening with a plurality of lumens disposed along a longitudinal axis of the inner conduit between the proximal and distal openings for establishing fluid flow communication between the proximal and distal end openings, wherein one of the plurality of lumens is disposed along the central axis of the hollow elongated body and surrounded by a remainder of the plurality of lumens in parallel arrangement along the longitudinal axis of the inner conduit; the multi-lumen aspirator device being in fluid flow communication with a source of vacuum for generating a suction force through the plurality of lumens such that the suction force generated by the vacuum source draws fluid and/or debris through the plurality of lumens, wherein the suction force generated by the vacuum source through the plurality of lumens establishes a laminar flow through the multi-lumen aspirator device.

14. The multi-lumen aspirator system of claim 13, wherein the distal opening of the hollow elongated body defines a S-curve configuration having a lower convex portion transitions to an upper concave portion.

15. The multi-lumen aspirator system of claim 13, wherein each of the plurality of lumens defines a same cross-sectional configuration.

16. The multi-lumen aspirator system of claim 15, wherein each of the plurality of lumens defines a circular cross-sectional configuration.

17. The multi-lumen aspirator system of claim 15, wherein each of the plurality of lumens defines an oval cross-sectional configuration.

18. The multi-lumen aspirator system of claim 15, wherein each of the plurality of lumens defines an elliptical cross-sectional configuration.

19. The multi-lumen aspirator system of claim 13, wherein each of the plurality of lumens is separated by the at least one interstitial space.

20. The multi-lumen aspirator system of claim 19, wherein the at least one interstitial space is filled with a material.
